(19) United States
(12) Patent Application Publication
(10) Pub. No.: US 2016/0180742 A1
(43) Pub. Date: Jun. 23, 2016

(54) PREPOSITION ERROR CORRECTING METHOD AND DEVICE PERFORMING SAME

(71) Applicant: POSTECH ACADEMY-INDUSTRY FOUNDATION, Pohang-si, Gyeongsangbuk-do (KR)

(72) Inventors: Geun Bae LEE, Pohang-si, Gyeongsangbuk-do (KR); Kyu Song LEE, Seoul (KR)

(21) Appl. No.: 14/909,565

(22) PCT Filed: Feb. 25, 2014
(86) PCT No.: PCT/KR2014/001514

§ 371 Date: Feb. 2, 2016

(30) Foreign Application Priority Data
Aug. 13, 2013 (KR) 10-2013-0096123

(51) Int. Cl. G09B 19/06; G06F 17/27

(52) U.S. Cl. CPC G09B 19/06; G06F 17/274; G06F 17/2755

(57) ABSTRACT

A method for correcting a preposition error and a device performing the same are provided. The method comprises the steps of normalizing input text by tagging the input text with part-of-speech information on words which form the input text; extracting a pattern indicating the structure of the input text on the basis of a preposition included in the nomalized input text; and correcting a preposition error included in the input text by matching an error pattern included in pre-constructed error pattern database and the extracted pattern. Therefore, the present invention can effectively correct a preposition error for a foreign language learner, and can precisely detect a preposition error of a foreign language learner, thereby enabling the foreign language learner to effectively learn grammar of a foreign language.

### TECHNICAL FIELD

The present invention relates to a foreign language learning, and more particularly to a method for correcting grammatical errors related to prepositions in a text inputted by a user and an apparatus performing the same.

### BACKGROUND ART

As needs for foreign language abilities are increasing in a modern society being globalized and internationalized, a foreign language education system for efficient learning of the foreign language is being studied actively.

Also, according to rapid developments of information communication technologies, a foreign language education utilizing information processing apparatuses such as a smart phone, a tablet PC, a Portable Multimedia Player (PMP), and a Personal Digital Assistant (PDA) is increasing.

Especially, as needs for learning foreign language grammars are increasing, systems, which can detect grammatical errors in a foreign language composition inputted from a user and provide correction information for the detected errors by utilizing such the information processing apparatuses, are being commercialized.

For example, as a representative computer program for correcting grammatical errors, a Microsoft (MS) word developed and commercialized by Microsoft can be considered. The MS word may provide a user with grammatical information by performing grammatical checks on spelling of a text written by a user and displaying grammatical errors detected in the text.

However, the MS word can detect and correct only simple grammatical errors in spelling of words included in the text or discrimination of capital letters and small letters, and cannot correct complicated grammatical errors based on part-of-speech information of words constituting the text.

Therefore, methods for correcting grammatical errors of the foreign language learner by pre-registering formats or grammatical rules for foreign language representation and methods for the same based on part-of-speech information of the foreign language have been proposed. However, since various formats or grammatical rules of foreign languages exist, it is very difficult to elaborately prepare grammatical rules for the methods.

Especially, since the number of grammatical rules needed for selection of prepositions is very great according to whether prepositions have temporal meaning or place implications, there is a limit in detecting and correcting grammatical errors in usage of prepositions.

### DISCLOSURE

### Technical Problem

The purpose of the present invention for resolving the above-described problems is to provide a method for efficiently correcting preposition errors of a foreign language learner by extracting a pattern of the preposition errors from an input text provided from the foreign language learner.

Also, another purpose of the present invention is to provide a method of correcting grammatical errors which can make foreign language learning be performed efficiently by detecting preposition errors included in the input text.

### Technical Solution

In some example embodiments of the present invention, a method of correcting a preposition error, performed in an information processing apparatus capable of digital signal processing, may comprise normalizing an input text by tagging words constituting the input text based on part-of-speech information of the words constituting the input text; extracting at least one pattern indicating a structure of the input text based on a preposition included in the normalized input text; and correcting a preposition error included in the input text by matching an error pattern included in a pre-constructed error pattern database and the extracted at least one pattern.

Here, the error pattern database may be constructed by verifying whether a preposition error exists or not through comparison between a pre-constructed grammatical error corpus and the at least extracted error pattern, and recording the at least one extracted pattern in the error pattern database when it is determined that the preposition error exists in the input text.

Here, the input text may be normalized by substituting a word having temporal meaning in the tagged input text with time-type information based on a text dictionary.

Here, the input text may be normalized by substituting a word having a place implication in the tagged input text with place-type information based on named entity recognition.

Here, the at least one pattern is extracted by extracting a plurality of word sequences by using words located prior to or subsequence to the preposition included in the normalized input text.

Also, the preposition error may be corrected by applying at least one of a probabilistic language model and a statistical language model to an error pattern matched to the error pattern database among the at least one extracted pattern.

In other example embodiments of the present invention, a preposition error correcting apparatus, may comprise a text normalization part normalizing an input text by tagging words constituting the input text based on part-of-speech information of the words constituting the input text; a pattern extraction part extracting at least one pattern indicating a structure of the input text based on a preposition included in the normalized input text; and an error correction part correcting a preposition error included in the input text by matching an error pattern included in a pre-constructed error pattern database and the extracted at least one pattern.

### Advantageous Effects

According to the above-described methods for correcting preposition errors and apparatuses for the same in accordance with exemplary embodiments of the present disclosure, preposition errors of a foreign language learner can efficiently be corrected by extracting patterns of preposition errors from an input text provided from a user.

Also, the preposition errors included in the can be correctly detected such that the foreign language learning can be performed efficiently.

### DESCRIPTION OF DRAWINGS

FIG. 1 is a flow chart to explain a method for correcting preposition errors according to an exemplary embodiment of the present disclosure.

FIG. 2 is a flow chart to explain a procedure of constructing an error pattern database according to an exemplary embodiment of the present disclosure.

FIG. 3 is an exemplary view to explain a procedure of normalizing an input text based on a text dictionary according to an exemplary embodiment of the present disclosure.

FIG. 4 is an exemplary view to explain a procedure of normalizing an input text based on named entity recognition according to an exemplary embodiment of the present disclosure.

FIG. 5 is an exemplary view to explain a procedure of extracting patterns from an input text according to an exemplary embodiment of the present disclosure.

FIG. 6 is a block diagram illustrating a preposition error correcting apparatus according to an exemplary embodiment of the present disclosure.

### BEST MODE

Example embodiments of the present invention are disclosed herein. However, specific structural and functional details disclosed herein are merely representative for purposes of describing example embodiments of the present invention, and example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The methods and apparatuses for correcting preposition errors and apparatuses according to exemplary embodiments of the present disclosure, which will be explained below, may be implemented in a user terminal and at least one server having capability of digital signal processing.

The user terminal may be connected to the at least one server or another user terminal via a wire or wireless network such as a Universal Serial Bus (USB), a Bluetooth, a Wireless-Fidelity (WiFi), a Long-Term Evolution (LTE), etc., and may exchange foreign language compositions and information for correction of preposition errors with each other.

Here, the at least one server may be a web server, and the user terminal may be an information processing apparatus which has an input device such as a keyboard, a mouse, and a touch screen, or a speech recognition device through which a user can input a text and which has information processing capability. For example, the user terminal may be a smartphone, a tablet PC, a Personal Digital Assistant (PDA), a laptop computer, or a computer. However, the user terminal is not restricted thereto.

Here, preferred exemplary embodiments will be explained in detail by referring accompanying figures.

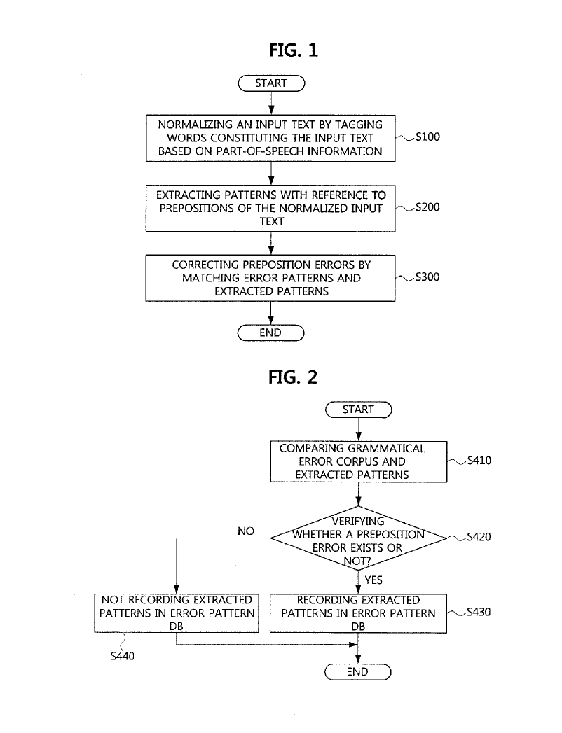

FIG. 1 is a flow chart to explain a method for correcting preposition errors according to an exemplary embodiment of the present disclosure.

Referring to FIG. 1, a method for correcting preposition errors, performed in an information processing apparatus, may comprise a step S100 of normalizing an input text, a step S200 of extracting a pattern from the normalized input text, and a step S300 of correcting preposition errors through a pattern matching.

Here, the input text may include any type of text or document comprising at least one word each of which can be used independently or which has a grammatical function as a combination of syllables, at least one phrase constructed as a combination of at least two words, and at least one sentence constructed as a combination of phrases. However, the input text is not restricted thereto.

A user may input the text by directly connecting the information processing apparatus or by using a speech recognition function equipped in the information processing apparatus.

If the text is provided by the user, the input text may be normalized by tagging words constituting the input text based on part-of-speech information of the words (S100). In this instance, even when words constituting two input texts are different, the input texts comprising a combination of words having the same part-of-speech can be normalized into the same format

For example, although a text “She was at the bank” and a text “He is at the airport” are different texts comprising different words, they are tagged based on the same part-of-speech information such as “personal pronoun (PP)+verb (VB)+ at +definite article (DA)+noun (NN)” such that they can be normalized into the same format.

Then, a word having temporal meaning (such as a time or a time point) in the tagged input text may be substituted with time-type information (i.e., a time-type tag) based on a pre-constructed text dictionary. Also, a word having a place implication (i.e., a word indicating a location) in the tagged input text may be substituted with place-type information (i.e., place-type tag) based on named entity recognition.

Since a preposition to be used may become different according to a type and position of a word having temporal meaning or place implication, the word may be substituted with the time type information or the place type information.

The text dictionary used for substituting the words having temporal meaning may be pre-constructed by classifying words having temporal meaning into types such as <DATE>, <MONTH>, <HOLIDAY>, <ORDNUM>, <INDAY>, <YEAR>, <NUM>, and <MEAL>.

For example, words such as ‘breakfast’, ‘lunch’, and ‘dinner’ are words representing meals, and may typically be used for representing temporal meaning in a text. Thus, the type of them may be preconfigured as <MEAL> in the text dictionary, which will be explained by referring to a table 1.

Thus, when one of ‘breakfast’, ‘lunch’, and ‘dinner’ is included in the input text, it may be tagged by using the tag <MEAL> predetermined in the text dictionary.

For the substitution of words representing place implications, named entity recognition may be used. According to the named entity recognition, a word corresponding to one of a person, a location, and an organization, in the input text, may be tagged by using the tag <PER>, <LOC>, or <ORG>.

For example, when a word representing a specific location, such as ‘Seoul’ or ‘New York’, is included in the input text, it may be tagged by using the tag <LOC> such that the input text can be normalized.

A plurality of patterns representing a structure of the input text may be extracted based on at least one preposition included in the normalized input text (S200). Specifically, a plurality of word sequences may be extracted by using words prior to or subsequent to a preposition included in the normalized input text.

For example, after the normalization on the input text such as “In late nineteenth century, there was a severe air crash happening on Miami international airport”, a plurality of word sequences may be extracted from the normalized text according to a predetermined window size.

Here, the predetermined window size may mean the predetermined number of words to be extracted from the input text. The word sequences can be extracted by using as many words prior to or subsequent to the preposition as the predetermined window size, and a plurality of patterns may be extracted from the extracted plurality of word sequences.

The input text may be normalized into “In late <ORDNUM> century, there was a severe air crash happening on <LOC> international airport.” by using the time-type information and the place-type information, and a plurality of word sequence may be extracted according to the predetermined window size (e.g., 3).

For example, with referent to the preposition ‘at’ included in the normalized input text, word sequences ‘crash happening on’, ‘happening on <LOC>’, and ‘on <LOC> international’ may be extracted by using words prior to or subsequent to ‘at’.

Although only an example for the case that the predetermined window size is configured as 3 is explained here, the predetermined window size is not restricted thereto. Various predetermined window sizes may be used for extracting the word sequences having various lengths.

A plurality of patterns extracted based on the plurality of word sequences may be pre-constructed as an error pattern database 130 through verification. More specifically, for a given text having grammatical errors, it is verified whether preposition errors exist in the given text by comparing a pre-constructed grammatical error corpus and the plurality of patterns, and the pattern verified as having preposition errors may be recorded into the error pattern database 130.

Here, the reason of the verification is for recording only valid patterns having preposition errors into the error pattern database 130 among a large number of patterns extracted by using the word sequences.

Accordingly, the grammatical error corpus is compared with the extracted patterns, and only matched patterns are recorded into the error pattern database 130. On the contrary, the patterns which are not matched to the grammatical error corpus are not recorded into the error pattern database 130 since they may be regarded to as non-valid patterns having no preposition errors.

Through matching between the error patterns included in the pre-constructed error pattern database 130 and the extracted patterns, preposition errors included in the input text may be corrected (S300).

More specifically, among the plurality of patterns extracted in reference to the preposition, a pattern matched to the error pattern included in the error pattern database 130 may be used for correcting preposition errors based on at least one of a probabilistic language model and a statistical language model.

Here, the probabilistic language model and the statistical language model may include various language models such as a machine learning based Nave Bayesian model, a hidden Markov model, an inductive decision-tree model, and a neural network. However, the models are not restricted thereto.

Also, although an exemplary embodiment for correcting a grammatical error of a preposition is described here, exemplary embodiments according to the present disclosure may be extended for various part-of-speeches such as rhetoric, determiner, prenoun, postposition, adjective, and adverb.

FIG. 2 is a flow chart to explain a procedure of constructing an error pattern database according to an exemplary embodiment of the present disclosure.

Referring to FIG. 2, the error pattern database 130 may be pre-constructed by comparing a grammatical error corpus and extracted patterns (S410) and verifying whether preposition errors exist or not (S420).

Here, the grammatical error corpus may be pre-constructed through machine learning on texts having grammatical errors.

When the input text is provided, the input text may be normalized by tagging words constituting the input text with corresponding tags based on part-of-speech information of the input text, the text dictionary, and the named entity recognition, and a plurality of word sequences may be extracted from the input text in reference to the preposition included in the normalized input text according to the predetermined window size.

Here, the predetermined window size may mean the predetermined number of words extracted from the input text. The word sequences can be extracted by using as many words prior to or subsequent to the preposition as the predetermined window size, and a plurality of patterns may be extracted from the extracted plurality of word sequences.

In order to verify whether a preposition error exists in the extracted plurality of patterns, the extracted plurality of patterns may be compared with the pre-constructed grammatical error corpus (S420).

Here, the reason of the verification is for recording only patterns having preposition errors into the error pattern database 130 among a large number of patterns extracted by using the word sequences.

Accordingly, the grammatical error corpus is compared with the extracted patterns, and only matched patterns are recorded into the error pattern database 130 (S430). On the contrary, the patterns which are not matched to the grammatical error corpus are not recorded into the error pattern database 130 since they may be regarded to as non-valid patterns having no preposition errors (S440).

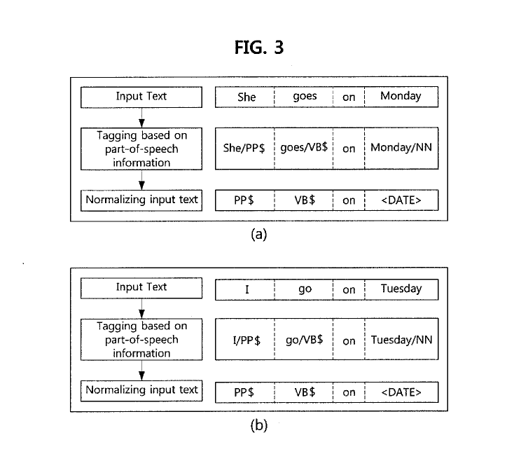

FIG. 3 is an exemplary view to explain a procedure of normalizing an input text based on a text dictionary according to an exemplary embodiment of the present disclosure.

Referring to FIG. 3, the input text may be normalized by tagging part-of-speeches of words constituting the input text based on the text dictionary.

As depicted in (a) of FIG. 3, words constituting the input text “She goes on Monday” may be tagged such that the input text is normalized into “She/PP$ goes/VB$ on Monday/NN”.

Here, ‘PP’ means a tag corresponding to a personal pronoun, ‘VB’ means a tag corresponding to a verb, and ‘NN’ means a tag corresponding to a noun. However, tags used for the present invention are not restricted thereto, and various formats of tags may be used for tagging the input text.

In the tagged input text, words having temporal meaning may be substituted with time-type information based on the pre-constructed text dictionary.

TABLE 1

| Type | Examples |
|---|---|
| <DATE> | Monday, Tuesday, Wednesday, Thursday, Friday, |
| | Saturday, Sunday |
| <MONTH> | January, February, March, April, May, June, July, |
| | August, September, October, November, December |
| <HOLIDAY> | Christmas, Thanksgiving, . . . |
| <ORDNUM> | 1^{st}, first, 2^{nd}, second, . . . |
| <INDAY> | Morning, Afternoon, Evening |
| <YEAR> | 1000~2100, . . . |
| <NUM> | 1, 2, 3, . . . , one, two, three, . . . |
| <MEAL> | Breakfast, Lunch, Dinner, . . . |

The table 1 illustrates an example of the pre-constructed text dictionary. By referring to the table 1, a word ‘Monday’ having temporal meaning may be substituted with the tag <DATE> such that the input text is normalized into “PP$ VB$ on <DATE>”.

As depicted in (b) of FIG. 3, words constituting the input text “I go on Tuesday” may be tagged such that the input text is normalized into “I/PP$ go/VB$ on Tuesday/NN”.

Also, the word ‘Tuesday’ having temporal meaning may be substituted with the tag <DATE> based on the text dictionary illustrated as the table 1 such that the input text is normalized into “PP$ VB$ on <DATE>”.

Here, as described above, although words constituting the input text “She goes on Monday” of (a) of FIG. 3 and the input text “I go on Tuesday” of (b) of FIG. 3 are different, they may be normalized into the same format “PP$ VB$ on <DATE>” based on respective part-of-speech information of them and the text dictionary.

Therefore, two input texts normalized into the same format “PP$ VB$ on <DATE>” may be identified as having the same pattern such that more accurate and valid patterns on preposition errors can be extracted.

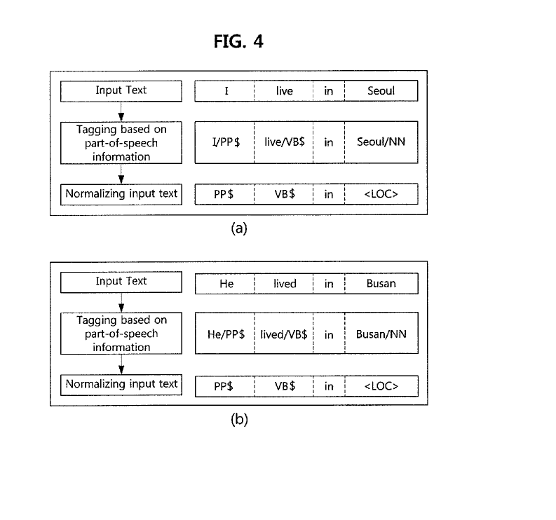

FIG. 4 is an exemplary view to explain a procedure of normalizing an input text based on named entity recognition according to an exemplary embodiment of the present disclosure.

Referring to FIG. 4, the input text may be normalized based on named entity recognition by tagging part-of-speeches of words constituting the input text.

As depicted in (a) of FIG. 4, words constituting the input text “I live in Seoul” may be tagged such that the input text is normalized into “I/PP$ live/VB$ in Seoul/NN”.

As described above, ‘PP’ means a tag corresponding to a personal pronoun, ‘VB’ means a tag corresponding to a verb, and ‘NN’ means a tag corresponding to a noun. However, tags used for the present invention are not restricted thereto, and various formats of tags may be used for tagging the input text.

In the tagged input text, words having place implication may be substituted with place-type information by using the named entity recognition method. More specifically, words indicating person, location, or organization, which are included in the input text, may be substituted with tags such as <PER>, <LOC>, or <ORG>such that the input text is normalized.

Therefore, the word ‘Seoul’ having a place implication may be substituted with the tag <LOC> such that the input text can be normalized into “PP$ VB$ in <LOC>.

Meanwhile, words constituting the input text “He lived in Busan” of (b) of FIG. 4 may be tagged with part-of-speech tags such that the input text can be normalized into “He/PP$ lived/VB$ in Busan/NN”.

Also, in the tagged input text, the word ‘Busan’ having a place implication may be substituted with the tag <LOC> by using the named entity recognition method such that the input text can be normalized into “PP$ VB$ in <LOC>”.

Here, as described above, although words constituting the input text “I live in Seoul” of (a) of FIG. 4 and the input text “He lived in Busan” of (b) of FIG. 4 are different, they may be normalized into the same format ‘PP$ VB$ in <LOC> based on respective part-of-speech information of them and the named entity recognition.

Therefore, two input texts normalized into the same format “PP$ VB$ in <LOC>” may be identified as having the same pattern such that more accurate and valid patterns on preposition errors can be extracted.

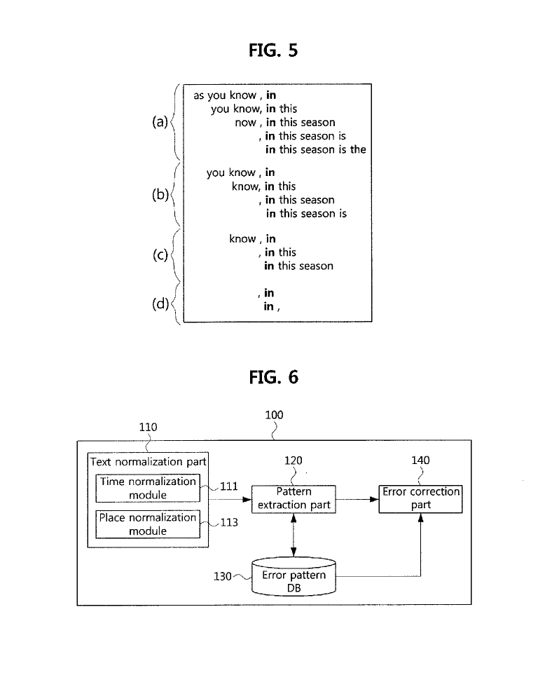

FIG. 5 is an exemplary view to explain a procedure of extracting patterns from an input text according to an exemplary embodiment of the present disclosure.

Referring to FIG. 5, a plurality of word sequences may be extracted from the input text by using words prior to or subsequent to a preposition included in the normalized text according to a predetermined window size such that a plurality of patterns can be extracted.

For example, word sequences corresponding to window sizes of 2 to 5 may be extracted from an input text “As you know, in this season is the end of the accounting term”. Here, the window size may mean the predetermined number of words extracted from the input text.

Specifically, word sequences (a) having the window size of 5 extracted from the input text as including the preposition ‘in’ may be ‘as you know, in’, ‘you know, in this’, ‘know, in this season’, ‘in this season is’, and ‘in this season is the’.

Also, word sequences (b) having the window size of 4 extracted from the input text as including the preposition ‘in’ may be ‘you know, in’, ‘know, in this’, ‘, in this season’, and ‘in this season is’.

Also, word sequences (c) having the window size of 3 extracted from the input text as including the preposition ‘in’ may be ‘know, in’, ‘, in this’, ‘in this season’, and ‘in this season’, and word sequences (d) having the window size of 2 extracted from the input text as including the preposition ‘in’ may be ‘, in’, and ‘in this’.

The word sequences extracted from the normalized input text according to the predetermined window size may be verified such that patterns having a preposition error can be extracted. Here, the reason of the verification is for recording only patterns having a preposition error into the error pattern database 130 among a large number of patterns extracted by using the word sequences.

For example, a plurality of patterns ‘in this season is’, ‘in this season VB’, ‘in this NN is’, ‘in this NN VB’, and ‘in DT NN ZB’ may be extracted from the word sequence ‘in this season is’, and patterns having a preposition error can be extracted among the plurality of patterns through the verification and machine-learning on the plurality of patterns.

FIG. 6 is a block diagram illustrating a preposition error correcting apparatus according to an exemplary embodiment of the present disclosure.

Referring to FIG. 6, a preposition error correcting apparatus 100 may comprise a text normalization part 110, a pattern extraction part 120, and an error correction part 140. Also, the apparatus 100 may further comprise the error pattern database 130.

The preposition error correcting apparatus 100 may be equipped in an information processing apparatus capable of information processing.

Here, the information processing apparatus may mean a user terminal which has an input device such as a keyboard, a mouse, and a touch screen, or a speech recognition device through which a user can input a text and which has information processing capability. For example, the user terminal may be a smartphone, a tablet PC, a Personal Digital Assistant (PDA), a laptop computer, or a computer. However, the information processing apparatus is not restricted thereto.

Also, the input text may include any type of text or document comprising at least one word each of which can be used independently or which has a grammatical function as a combination of syllables, at least one phrase constructed as a combination of at least two words, and at least one sentence constructed as a combination of phrases. However, the input text is not restricted thereto.

The text normalization part 110 may normalize the input text by tagging words constituting the input text based on part-of-speech information of the words. More specifically, the input text may be normalized by substituting the words constituting the text with corresponding part-of-speech tags.

Accordingly, even when words constituting two input texts are different, the input texts comprising a combination of words having the same part-of-speech can be normalized into the same format.

The text normalization part 110 may further include a time normalization module 111 and a place normalization module 113.

The time normalization module 111 may substitute words having temporal meaning in the tagged input text with time-type information (i.e., time-type tags) based on a pre-constructed text dictionary.

Here, the text dictionary used for substituting the words having temporal meaning may be pre-constructed by classifying words having temporal meaning into types such as <DATE>, <MONTH>, <HOLIDAY>, <ORDNUM>, <INDAY>, <YEAR>, <NUM>, and <MEAL>.

Accordingly, when a word having temporal meaning is included in the input text, it may be tagged by using the tag corresponding to the type of temporal meaning represented by the word which was predetermined in the text dictionary.

The place normalization module 113 may substitute words having place implications in the tagged input text with place-type information (i.e., place-type tags) based on named entity recognition.

Here, according to the named entity recognition, a word corresponding to one of a person, a location, and an organization, in the input text, may be substituted with the tag such as <PER>, <LOC>, or <ORG>m and thus the input text can be normalized.

The reason of normalizing the input text by substituting words having temporal meaning or place implications with the time-type tags or the place-type tags is that a preposition is a part-of-speech which is located before or after a noun or a pronoun and represents a relation to the noun or the pronoun, and thus it may represent different meaning according to the type of word (especially, having temporal meaning or place implications) prior to or subsequent to it.

The pattern extraction part 120 may extract patterns representing a structure of the input text with reference to prepositions included in the normalized input text. That is, a plurality of word sequence may be extracted from the input text with reference to the preposition included in the normalized text such that a plurality of patterns can be extracted.

Here, the predetermined window size may mean the predetermined number of words to be extracted from the input text. The word sequences can be extracted by using as many words prior to or subsequent to the preposition as the predetermined window size, and a plurality of patterns may be extracted from the extracted plurality of word sequences.

A plurality of patterns extracted based on the plurality of word sequences may be pre-constructed as an error pattern database 130 through verification. More specifically, for a given text having grammatical errors, it is verified whether preposition errors exist in the given text by comparing a pre-constructed grammatical error corpus and the plurality of patterns, and the pattern verified as having preposition errors may be recorded into the error pattern database 130.

Here, the reason of the verification is for recording only valid patterns having preposition errors into the error pattern database 130 among a large number of patterns extracted by using the word sequences.

Accordingly, the grammatical error corpus is compared with the extracted patterns, and only matched patterns are recorded into the error pattern database 130. On the contrary, the patterns which are not matched to the grammatical error corpus are not recorded into the error pattern database 130 since they may be regarded to as non-valid patterns having no preposition errors.

The error correction part 140 may correct preposition errors included in the input text by using at least one of a probabilistic language model and a statistical language model for a pattern matched to the error pattern included in the error pattern database 130 among the plurality of patterns extracted with reference to the preposition.

Here, the probabilistic language model and the statistical language model may include various language models such as a machine learning based Nave Bayesian model, a hidden Markov model, an inductive decision-tree model, and a neural network. However, the models are not restricted thereto.

Also, although an exemplary embodiment for correcting a grammatical error of a preposition is described here, exemplary embodiments according to the present disclosure may be extended for various part-of-speeches such as rhetoric, determiner, prenoun, postposition, adjective, and adverb.

According to the above-described methods for correcting preposition errors and apparatuses for the same in accordance with exemplary embodiments of the present disclosure, preposition errors of a foreign language learner can efficiently be corrected by extracting patterns of preposition errors from an input text provided from a user.

Also, the preposition errors included in the input can be correctly detected such that the foreign language learning can be performed efficiently.

While the example embodiments of the present invention and their advantages have been described in detail, it should be understood that various changes, substitutions and alterations may be made herein without departing from the scope of the invention.

1. A method of correcting a preposition error, performed in an information processing apparatus capable of digital signal processing, the method comprising:
normalizing an input text by tagging words constituting the input text based on part-of-speech information of the words constituting the input text;
extracting at least one pattern indicating a structure of the input text based on a preposition included in the normalized input text; and
correcting a preposition error included in the input text by matching an error pattern included in a pre-constructed error pattern database and the extracted at least one pattern.

2. The method according to claim 1, wherein the error pattern database is constructed by verifying whether a preposition error exists or not through comparison between a pre-constructed grammatical error corpus and the at least one extracted error pattern, and recording the extracted at least one pattern in the error pattern database when it is determined that the preposition error exists in the input text.

3. The method according to claim 1, wherein the input text is normalized by substituting a word having temporal meaning in the tagged input text with time-type information based on a text dictionary.

4. The method according to claim 1, wherein the input text is normalized by substituting a word having a place implication in the tagged input text with place-type information based on named entity recognition.

5. The method according to claim 1, wherein the at least one pattern is extracted by extracting a plurality of word sequences by using words located prior to or subsequence to the preposition included in the normalized input text.

6. The method according to claim 5, wherein the preposition error is corrected by applying at least one of a probabilistic language model and a statistical language model to an error pattern matched to the error pattern database among the at least one extracted pattern.

7. A preposition error correcting apparatus, the apparatus comprising:
a text normalization part normalizing an input text by tagging words constituting the input text based on part-of-speech information of the words constituting the input text;
a pattern extraction part extracting at least one pattern indicating a structure of the input text based on a preposition included in the normalized input text; and
an error correction part correcting a preposition error included in the input text by matching an error pattern included in a pre-constructed error pattern database and the extracted at least one pattern.

8. The apparatus according to claim 7, wherein the error pattern database is constructed by verifying whether a preposition error exists or not through comparison between a pre-constructed grammatical error corpus and the extracted at least one error pattern, and recording the extracted at least one pattern in the error pattern database when it is determined that the preposition error exists in the input text.

9. The apparatus according to claim 7, wherein the text normalization part includes a time normalization module normalizing the input text by substituting a word having temporal meaning in the tagged input text with time-type information based on a text dictionary.

10. The apparatus according to claim 7, wherein the text normalization part includes a place normalization module substituting a word having a place implication in the tagged input text with place-type information based on named entity recognition.

11. The apparatus according to claim 7, wherein the pattern extraction part extracts the at least one pattern by extracting a plurality of word sequences by using words located prior to or subsequence to the preposition included in the normalized input text.

12. The apparatus according to claim 11, wherein the error correction part corrects the preposition error by applying at least one of a probabilistic language model and a statistical language model to an error pattern matched to the error pattern database among the at least one extracted patter
